(19) United States
(12) Patent Application Publication
(10) Pub. No.: US 2008/0169423 A1
(43) Pub. Date: Jul. 17, 2008

(54) Test apparatus for testing the operability of a warning system for approaching guided missiles

(76) Inventors: Christoph Betschart, Interlaken (CH); Benjamin Wepfer, Aarberg (CH)

Correspondence Address: DUNLAP CODDING & ROGERS, P.C., PO BOX 16370, OKLAHOMA CITY, OK, 73113, US

(21) Appl. No.: 11/652,301

(22) Filed: Jan. 11, 2007

(51) Int. Cl. G01J 5/10

(52) U.S. Cl. 250/372; 250/504 R

(57) ABSTRACT

The Missile Approach Warning Sensor Test apparatus, MAWST, serves to test the operability of a missile-approach warning system, MAWS, operating in the solar-blind UV-C range and/or in the IR range. The system, which finds application in military and civilian aircraft, vehicles, and ships, reacts to the radiation emission of an approaching guided missile and triggers protective measures. The test apparatus stimulates the MAWS by means of a simulated radiation emission. The test apparatus contains the following components: a UVC-LED which emits UV light in the range of 240 to 290 nm and a controller which activates at least the UVC-LED so that it simulates an emission profile of a guided missile.

The present invention relates to the field of self-defense systems intended to protect aircraft, vehicles, ships, etc., and their passengers, from attacks. These systems comprise sensors which react to emissions emanating from an approaching weapons system such as a rocket or guided missile. If such a system has recognized an approaching guided missile, a defense system can be activated, the effect of which is that this rocket cannot become dangerous to the target. By way of precaution, these sensors of the self-defense systems should be tested for proper operation prior to each use. In particular, the present invention relates to test apparatus which simulate a danger situation and confirm the operability of the self-defense system to the crew or maintenance personnel.

The public was first made aware of the danger presented by IR rockets through a rocket attack on 29 Nov. 2002 on an Israeli civilian aircraft in Kenya. Not just military aircraft but also civilian aircraft are exposed to such endangerment from terrorist activities. In recent years, the danger has increased through the spread of shoulder-fired rockets (MANPADS=man-portable air defense), “Stinger,” SAM 6, SAM 18, since thousands of them are available on the black market. These rockets have a heated-guided target system (IR) which directs the rocket toward the heat of the engines. Because of the range of such rockets, the danger exists essentially in the starting and landing phases.

With the introduction of modern self-defense systems on aircraft and helicopters, complex and sensitive environmental sensors are used, which are necessary for the detection of rapidly approaching dangers. U.S. Patent Application No. 2005/0150371 A1 describes a countermeasure system for defending aircraft against rocket attacks. The system comprises a detector situated on the ground, but which can alternatively be mounted on the aircraft instead. If the system detects an approaching rocket, a cloud of fluorescent nanocrystals is scattered. The cloud of nanocrystals produced is then activated by radiation, e.g., by laser, in order to generate a decoy hotspot for the guided missile and to distract it from the aircraft. U.S. Patent Application No. 2005/0029394 A1 describes a conformal air defense system which can be mounted on the outside of an aircraft. The system contains a sensor and also a countermeasure system. Further such systems are described, for example, in U.S. Patent Application No. 2004/0174290 A1 and in U.S. Pat. No. 5,850,285. Testing devices for the sensor systems are not mentioned in these documents.

Each engine of a flying guided missile also emits UV rays in addition to IR rays. Hence a “Missile Approach Warning Sensor” (MAWS) continuously searches the environment for suspicious sources of IR and/or UV. If the MAWS discovers a suspicious source, a special mathematical algorithm analyzes the intensity course of the source. An approaching missile gives itself away by means of a specific “missile profile” which increases in intensity. A MAWS must capture this threat quickly so that necessary counter-measures can be initiated in time. The direction from which a danger is approaching is depicted on a display in the cockpit.

Hence the regular operating check of such sensors is of vital importance and is generally carried out prior to each mission.

The earlier stimulus technology, based upon hot sources (with IR, visible, and UV portions), can fulfill the requirements for a manual apparatus only to a limited extent owing to the high energy demand and the danger of overheating. The halogen and gas-discharge lamps used according to the prior art are not well suited to manual apparatus. These disadvantages could be avoided with an expedient UV source which would also be suitable for a hand-held MAWS test apparatus.

Thus, there is a need for a test apparatus which can simulate the UV radiation of a missile, which is light, compact, mobile, and easy to use, but which also operates reliably under the most severe environmental conditions. Such an apparatus should perform this function as an autonomous hand-held apparatus.

Hence it is an object of the present invention to provide such an apparatus.

This object is achieved by the missile-approach warning sensor tester (MAWST) according to the definitions in the claims.

### BRIEF DESCRIPTION OF THE DRAWINGS

FIG. 1 shows the difference between a conventional test apparatus with a lamp and the apparatus according to the invention.

FIG. 2 shows the intensity curve of the emission of an approaching guided missile.

FIG. 3 depicts a measurement set-up having an MAWST according to the invention.

FIG. 4 is a block circuit diagram containing the essential elements of a test apparatus according to the invention.

FIG. 5 shows a suitable control circuit of a microcontroller.

FIG. 6 is a diagram of the intensity course of the UVC-LED used.

FIG. 7 shows the MAWST built into a housing.

FIG. 8 shows a further design of the MAWST according to the invention having a controlled light output.

FIG. 9 shows an embodiment having power-output compensation by means of an automatic distance measurement.

FIG. 10 shows a further embodiment of an MAWST in which the optical signal of a missile approach simulator is fed in very close to the missile approach warning sensor.

FIGS. 11 to 13 are structure charts which served as a basis for programming the microcontroller.

The most efficient light source in the present state of the art is the light-emitting diode (LED) used in many products as a lighting fixture or pilot lamp. High light yield, long life, and high efficiency characterize this technology, which has proved itself for decades now. Manufacturers supply many different sizes, performance classes, and wavelengths.

It has been found that LED technology is suitable for a MAWS test apparatus (MAWST) and that such LEDs have already been developed.

While high-performing IR-LEDs are available in commerce, however, there are only a few products among the wavelengths in the UV range having shorter wavelengths suitable for MAWSTs. They generally have the following drawbacks: low efficiency rating, no high power output, relatively short life compared to standard LEDs; there are only a few procurement sources of LEDs which emit below 300 nm. Proposed applications for these new UVC-LEDs reside in the purification of liquids (preparation of drinking water or cleaning of swimming pools). However, military applications are also being examined, e.g., for data transmission. The data are sent via UV radiation into the sky. The rays are then diffusely reflected. This type of transmission is probably suitable only for short distances (within a command post). Its application in missile approach simulators has not been proposed until now.

For the present invention, a commercially available UVC-LED has been used, emitting light waves in the range of about 265 nm wavelength. Since this wavelength is also still contained in the bandwidth for UV-MAW sensors (which detect primarily in the solar-blind range), such UVC-LEDs are ideal for this application. The relatively short life of the UVC-LEDs currently available is no serious drawback for the simulation since a UVC-LED used for a test is operated for only a few seconds.

In order for the MAWS test apparatus (MAWST) to come as close as possible regarding UV to the real guided missile with its characteristics, measurements have been carried out and verified on an integrated self-defense system in an aircraft.

The MAWST is programmed in such a way that upon activation, a UV emission profile of an approaching guided missile is simulated by means of a UV source, according to the invention by means of a UVC-LED. In the case of this profile, the intensity course is decisive so that the sensor can really can perceive the light source as a danger. The danger recognized by the sensor, and its direction, are transmitted from the MAWS to the cockpit, where the danger is called to the attention of the pilot on a display, countermeasures being taken immediately in case of danger (for guided missiles mostly flares, which are supposed to act as a disruptive source of heat). However, since the internal selftest cannot check the operation of all parts of the MAWS prior to takeoff, an external test is needed for the sensor. This test is supposed to prove the operability of the sensor once more and/or to lessen sources of error on parts not to be checked electronically, such as soiled protective glass in front of a sensor.

Thus, the MAWST must simulate a guided missile as regards the UV radiation in such a way that danger is really recognized as such by the sensor. Since most MAWSs work in the UV range, a light source in this range is needed for a test apparatus. In order to simulate the MAWSs available on the market, a source in the UVC range is needed (for more exact explanations, see below in the present specification).

The power supply of the MAWST, which is supposed to operate as an autonomous apparatus, is preferably a secondary cell or a non-rechargeable battery.

As an operating element, a button can be provided by means of which the profile can be started or ended by closing a circuit for the necessary length of time.

As in the case of other similar apparatus, a programmable controller is used in the MAWST in order to compensate for non-linearities or other influences.

The set values of a UV emission profile of an approaching generic guided missile come from calculated profiles or from genuine records which can be loaded into the MAWST. The values describe an intensity course of an approaching guided missile. The shapes of the curves are roughly based on a quadratic function since the light output also bears a quadratic relationship to the distance. The controlled system (outside of and/or within the microcontroller) consists of an amplifier member and the UV-LED. The amplifier is necessary since the working point of the UV-LED is situated only above the feed voltage of the microcontroller. Voltage, current, and temperature of the UV-LED are returned to the controller as actual values and may be used for control purposes.

The above-described version of the MAWST is an economical version. Additional functions may also be integrated in the apparatus, which may also be taken into account in mass production.

Calibration of the MAWST takes place by means of external equipment.

UV-LED

The UVC-LEDs used were UVTOP® LEDs from Sensor Electronic Technology, Inc., 1195 Atlas Road, Columbia, S.C. 29209, U.S.A. For the product UVTOP-265, a peak wavelength with 263+/−7 nm is indicated. This was confirmed by a measurement made by Applicant. The spectrum half-width of 12-20 nm was also adhered to. However, other such products which meet the prerequisites may also be used.

Used for measurements of the power output was a universal light output measurement apparatus (model 841-PE, UC-sensor 818) from Newport Corporation, 8 East Forge Parkway, Franklin, Mass. 02038, U.S.A., to which calibrated power sensors can be attached. The data sheet of the sensor and of the display unit may be seen on the website www.newport.com.

The distance between the MAWST and the MAW sensor on the ISSYS is furthermore of importance since the light output decreases quadratically as the distance increases.

In one embodiment of the test apparatus, a range-finder is therefore integrated which, when the test apparatus is used in activated condition, measures the distance between the UVC-LED and the sensor of the MAWS. Depending upon the distance, the optical output line is controlled by the programmable controller in such a way that the output of the UVC-LED lies within the desired specification. The user need no longer bother about the distance to the sensor.

In a special embodiment of the test apparatus, a measuring sensor is disposed before the UVC-LED for measuring the intensity of the emitted radiation and controlling it by means of the controller, the arrangement with the measuring sensor containing a semi-transparent mirror which diverts part of the optical signal to the measuring sensor for the measurement.

A further embodiment of the test apparatus additionally presents a light-guide cable disposed before the UVC-LED for relaying the optical signal delivered. The optical signal may thereby be fed in close to the sensor of the MAWS for the purpose of a shielded simulation.

Hardware

The core component of the MAWST is a programmable controller. It controls and monitors the assemblies on the circuit board.

Activation of the UV Source

As may be seen from the above remarks, the light output is controlled via the current. The circuit is based upon the principle of a controlled current source having an operational amplifier. The current is led back to the inverted input on the OPAMP via a shunt. The set value is supplied to the positive input. Therefore, the output voltage now runs up until the difference between the positive and the inverted input is zero.

Housing

One version of a housing is made of fiberglass-reinforced plastic (FRP), which provides a simple solution for changing the battery.

Software

Activation of the inserted assemblies and, above all, of the UV-LED takes place via the programmable controller. This necessitates suitable firmware in the controller and profile data for the correct activation and monitoring.

The present invention will be explained in detail with the aid of the accompanying drawings.

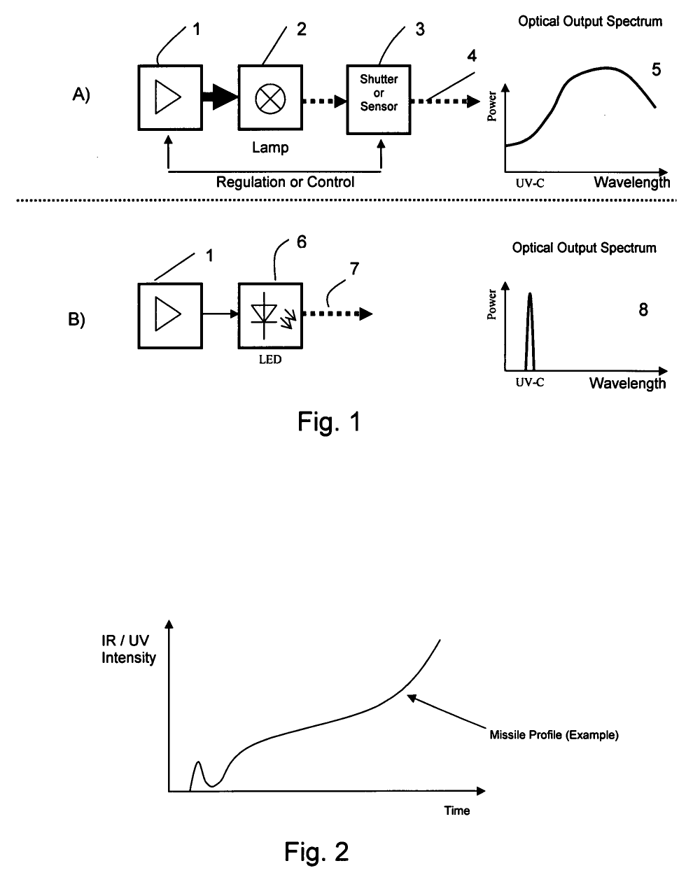

FIG. 1 shows the difference between a conventional test apparatus having a lamp and the LED apparatus according to the invention. Since most missiles operate with sensors in the infrared and ultraviolet ranges, various lamp solutions having halogen lamps and various gas-discharge lamps have heretofore been used for test apparatus. One example of an arrangement is depicted under A) in FIG. 1. Reference numeral 1 indicates the electronics assembly, including feed supply and controller, which controls the lamp 2. Extravagant optical filters, shutter 3, were necessary, the power output of which must be regulated in the required spectral range in order to achieve the desired radiation intensity 4. The non-linearities, too, as well as rapid changes in intensity with control devices had to be taken into consideration by the electronics assembly. These solutions are expensive, require a great deal of energy, are impractical to use, and are often not reliable. Under B) in FIG. 1, the arrangement according to the invention is depicted. It likewise comprises electronics assembly 1, which has to regulate the LED 6 alone in order for the desired radiation intensity 7 to be reached. Further to be seen diagrammatically from the representation is the difference between the output spectra 5 and 8.

FIG. 2 shows the intensity curve of a guided missile approaching the MAWS. The intensity according to this curve must be simulated by the MAWST according to the invention, a calculated curve being used.

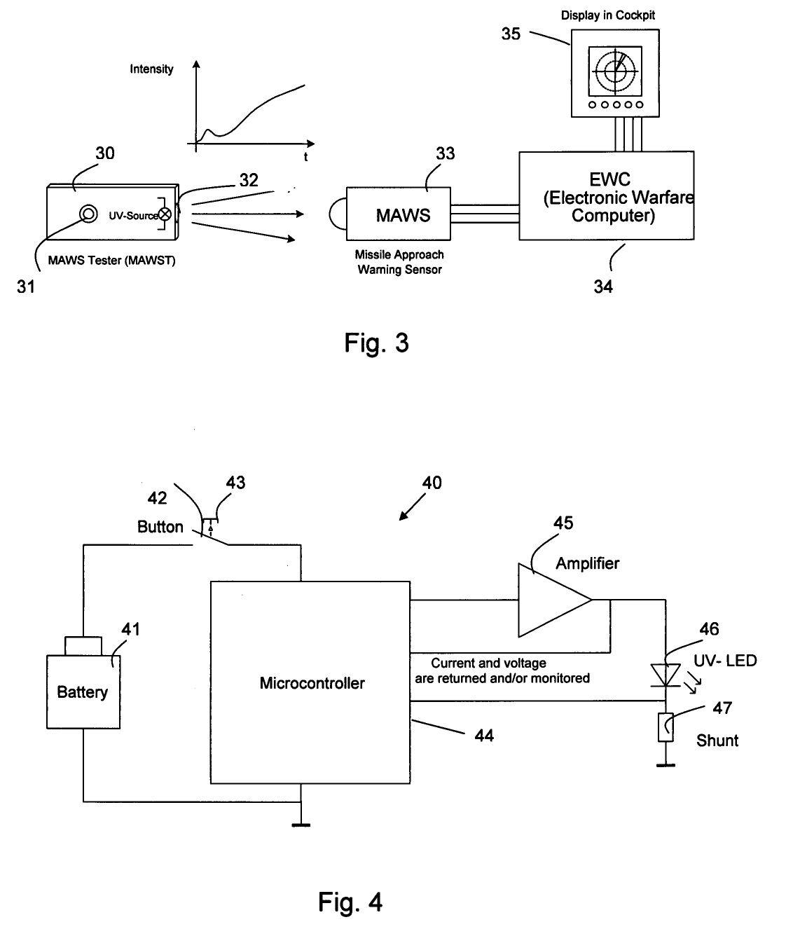

FIG. 3 depicts a measuring arrangement having an MAWST 30 according to the invention. When the operator presses the button 31, the UVC-LED 32 is activated and radiates with a predetermined intensity pattern on the sensor 33 of the MAWS. The signal is processed by the electronics assembly 34 (here EWC) and in the test case relayed only to a display 35 in the cockpit, where the operability of the MAWS is confirmed.

FIG. 4 shows a block circuit diagram containing the essential elements of a test apparatus 40 according to the invention. The power source 41 ensures that the MAWST can operate as an autonomous apparatus. The power source 41 is a secondary cell or a battery and supplies the microcontroller 44 with the necessary energy for the UV-LED 46 and for the control when the user activates the starting mechanism by means of the button 43. The light output is controlled via the current, an operational amplifier 45 (OPAMP) being utilized, which can be used as a controller. The current is returned via a shunt 47 to the inverted input of the OPAMP. The set value is supplied to the positive input.

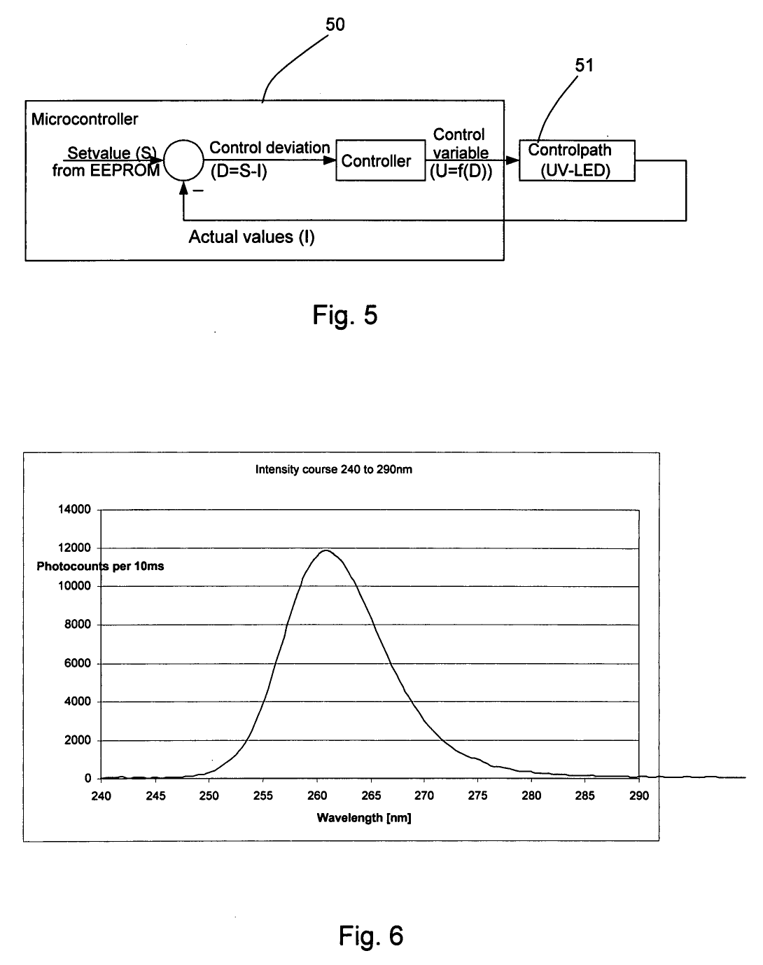

FIG. 5 shows a suitable control circuit of a microcontroller 50. The set values (S) are assembled from a generic profile. As a rule, not a profile of an existing guided missile is utilized for the for the functional model but rather a calculated profile. The values describe an intensity course of an approaching guided missile. The curve shape is roughly based upon a quadratic function since the light output also acts quadratically to the distance. The controlled system 51 (outside the microcontroller) consists of an amplifier member and the UV-LED. The amplifier is necessary since the UV-LED begins to conduct only above the feed voltage of the microcontroller. Thus activation via a “normal” output of the controller is not possible. Voltage, current, and temperature of the UV-LED are returned to the controller as actual values.

FIG. 6 shows a diagram of the intensity course of the UVC-LED used, of the type UVTOP-265 from Sensor Electronic Technology, Inc., Columbia, S.C. 29209, U.S.A.

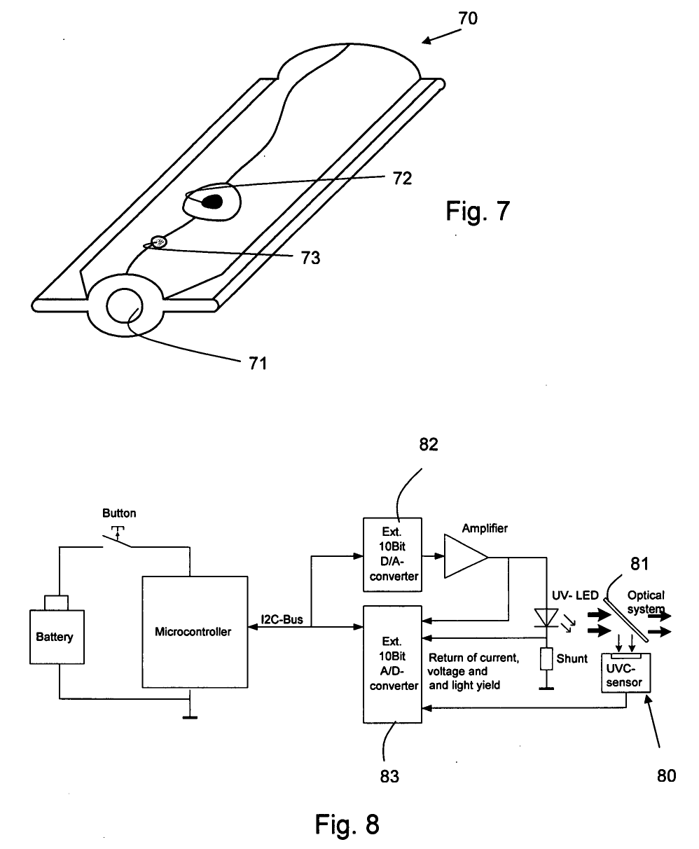

FIG. 7 shows an MAWST mounted in a housing 70, with the UVC-LED 71, the button 72, and a pilot light 73.

FIG. 8 shows a further design of the MAWST according to the invention having a controlled light output. The arrangement corresponds to that of FIG. 4, but with the intensity of the UV ray additionally being measured by a measuring-sensor arrangement 80 and by additional electronic components 82, 83. By means of a permeable mirror 81 as optical system, a small portion of the UV light intended for the MAWS sensor is deviated to the measuring sensor, which transmits corresponding signals to the component 83. The variations at the UVC-LED, which may occur owing to outside influences or aging, are thereby taken into account. This embodiment is not limited just to the use of a UV-LED but may also be used with MAWSTs which operate in the IR range and/or use lamps or other radiation sources.

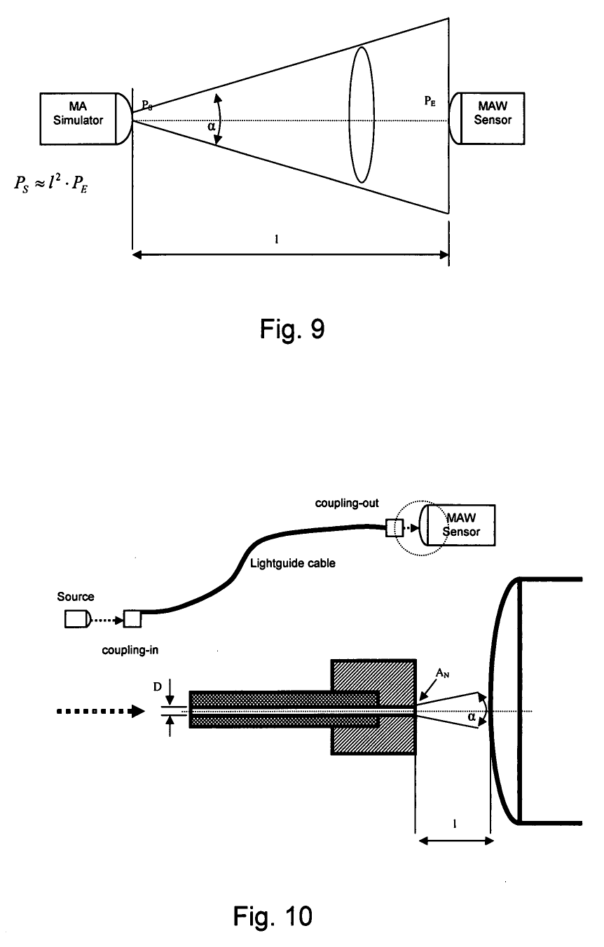

FIG. 9 shows an embodiment having a power output compensation by means of an automatic distance measurement. The MAWST detects a threat with the aid of the optical power input PE=f(t). This optical yield is an important parameter and must therefore lie within the specification. The ratio of the power input arriving at the sensor during a missile approach simulation is PE□PS/12. The distance has a great influence upon the power input and is thus a critical magnitude. Incorporated in the missile approach simulator is a range-finder which measures the path between the simulator and the MAW sensor. Depending upon the distance, the optical power output at the simulator is adapted. It is thereby ensured that the optical yield at the MAW sensor is always within the desired specification. The user need no longer bother about the distance to the sensor. This embodiment is not limited just to the use of a UVC-LED but may also be used with MAWSTs which operate in the IR range and/or use lamps or other radiation sources. In the drawing: PS=transmitter power; PE=receiver power; I=distance between transmitter and receiver.

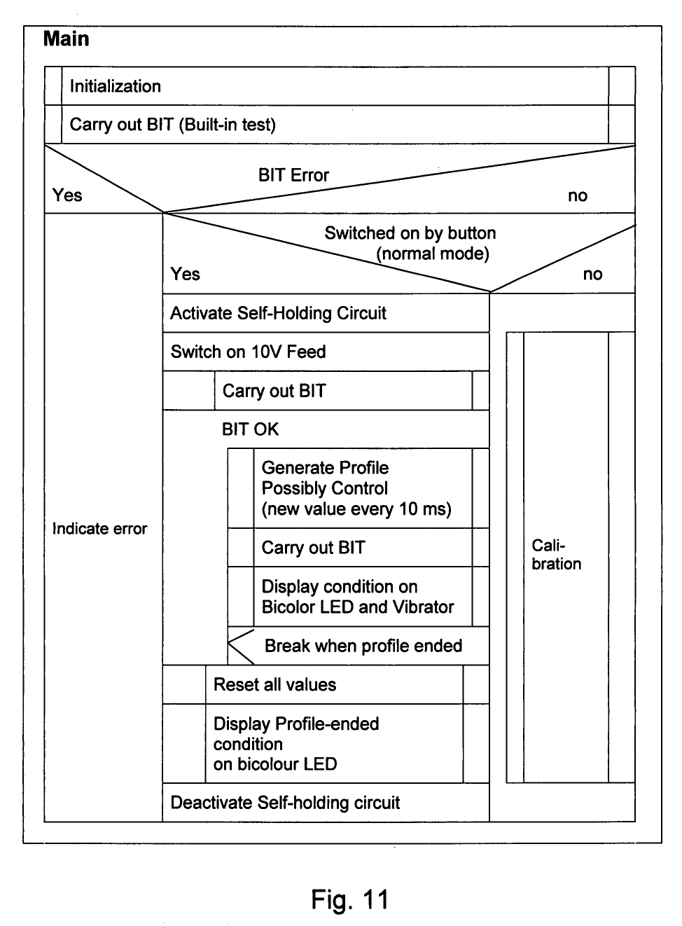

FIG. 10 shows a further embodiment of an MAWST in which the optical signal of a missile approach simulator is fed in very close to the missile approach warning sensor. This minimal distance default value makes it possible to carry out shielded simulations. Since the optical system of a MAW sensor is permanently focused at a long distance, the optical system must be circumvented when the optical signal is fed in from a short distance. For this purpose, the use of light-guide cable having an optical transmission of 160-10,000 nm is proposed. Conditioned by the numerical aperture and the fiber diameter, the optical performance can be adapted and the exit angle calculated. The MAW sensor “sees” the optical signal sharply with a small fiber diameter despite a short distance. The lower part of the drawing shows a detail of the part situated in the dotted-line circle of the upper overview drawing.

This embodiment is not limited to the use of a UVC-LED but may also be applied for MAWSTs which operate in the IR range and/or use lamps or

other radiation sources. In this representation:

$$α = 2 \cdot arc sin ( \frac{{A}_{N}}{η} ) ,$$

wherein AN: numerical aperture of the fibers; η: index of refraction (air=1.00, quartz=1.46); D: diameter of glass fiber and/or fiber bundle; α: optical exit angle; I: distance from coupling-out—MAW sensor.

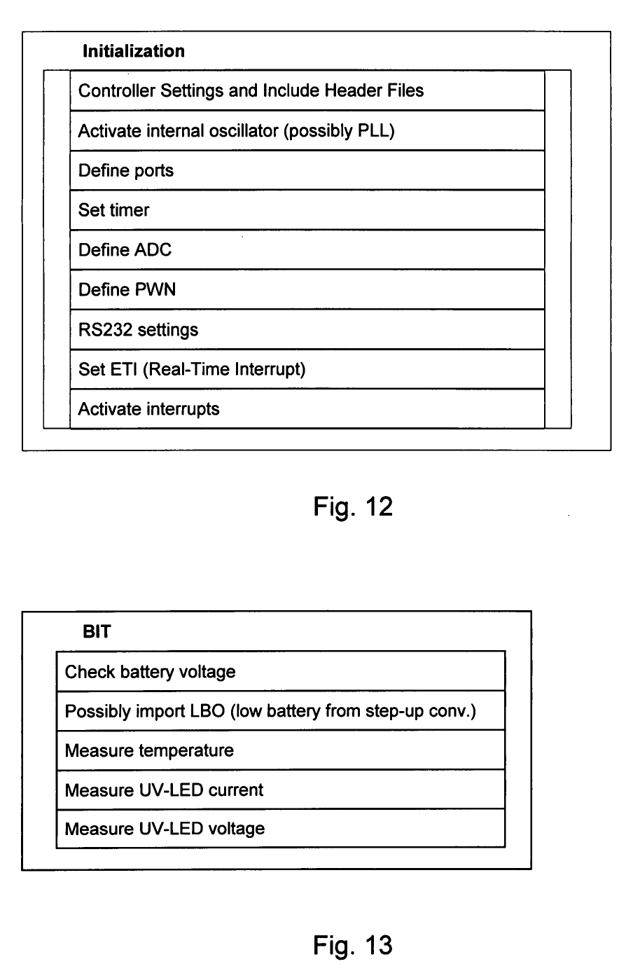

FIGS. 11 to 13 are structure charts which served as a basis for programming the controller so that the activation of the assemblies utilized, and above all of the UV-LED, functions smoothly.

1. Missile Approach Warning Sensor Test apparatus, MAWST, for testing the operability of a warning system for approaching guided missiles or a Missile-Approach Warning Sensor, MAWS, in the solar-blind range, UV-C, especially for aircraft, vehicles, and ships, the UV sensor reacting to the radiation emission of an approaching guided missile and triggering protective measures in that the UV sensor is stimulated by a radiation emission of the test apparatus, the test apparatus comprising the following components:
a UVC-LED which emits UV light in the solar-blind range, UV-C, from 240 to 290 nm, and
a programmable controller which activates at least the UVC-LED.

2. Test apparatus according to claim 1, further comprising switching-on means and a current source, the current source preferably being a secondary cell or a battery.

3. Test apparatus according to claim 1 or 2, wherein the UVC-LED operates in the range from 250 to 270 nm and with a maximum intensity of about 261 nm.

4. Test apparatus according to one of the claims 1 to 3, wherein it has an indicator means which is activated by the controller and indicates when the UVC-LED is switched on.

5. Test apparatus according to claim 4, wherein the indicator means is a pilot light, a vibramotor, or an acoustic means.

6. Test apparatus according to one of the claims 1 to 5, wherein the controller is programmed in such a way that it generates a computed or freely programmed profile corresponding to the intensity course of an approaching guided missile.

7. Test apparatus according to one of the claims 2 to 5, wherein the switching-on means is operated by a button, the switching-on means being so triggered by the controller that upon pressing the button, a predetermined switched-on duration is achieved with the programmed intensity protocol.

8. Test apparatus according to one of the claims 1 to 7, wherein the test apparatus incorporates a range-finder which, when the test apparatus is used in switched-on condition, measures the distance between the UVC-LED and the MAWS, the UV-LED being so controlled by the controller that the output of the UVC-LED is optimally adjusted as a function of the distance corresponding to the default value for the system to be tested.

9. Test apparatus according to one of the claims 1 to 8, wherein a measuring sensor is disposed before the UVC-LED which measuring sensor measures the intensity of the emitted radiation and regulates it by means of the controller, the arrangement with the measuring sensor containing a semi-transparent mirror which diverts part of the optical signal to the measuring sensor for the measurement.

10. Test apparatus according to one of the claims 1 to 9, further comprising a light-guide cable disposed before the UVC-LED for relaying the emitted optical signal so that the optical signal, preferably for the purpose of a shielded simulation, can be fed in close to the sensor of the MAWS.
